(19) United States
(12) Patent Application Publication
(10) Pub. No.: US 2018/0360000 A1
(43) Pub. Date: Dec. 20, 2018

(54) High Lift Feeder Protector

(71) Applicant: Russell Jeffrey Cahill, Woodland Park, CO (US)

(72) Inventor: Russell Jeffrey Cahill, Woodland Park, CO (US)

(21) Appl. No.: 16/029,493

(22) Filed: Jul. 6, 2018

Related U.S. Application Data
(60) Provisional application No. 62/502,664, filed on May 6, 2017.

(51) Int. Cl. A01K 39/01; F16M 11/04; A01K 5/00

(52) U.S. Cl. CPC A01K 39/0113; A01K 5/00; F16M 11/046

(57) ABSTRACT

A high lift feeder protector has mounting, vertical extension, and horizontal extension members, which can be hollow to allow a suspension rope to run therethrough. The members together can resemble an extended cane. The far end of the suspension rope attaches to a feeder. The rope runs up from the feeder, into an output port on the underside of the horizontal extension member, through the horizontal extension member, through the vertical extension member, through the mounting member, and then extends out an input port at the near end thereof. The tag end of the suspension rope can then be affixed to a cleat, winch or other securing device. A rope stop can be affixed near the tag end and should be large enough that it cannot fit within the input port. Thus, the rope stop functions to stop the rope from feeding completely in and through the members.

### CROSS-REFERENCE TO RELATED APPLICATIONS

This application claims the benefit of U.S. Provisional Application No. 62/502,664 and having a filing date of May 8, 2017, which is specifically incorporated by reference herein for all that it discloses and teaches.

### TECHNICAL FIELD

The present invention relates generally to the field of animal/bird feeders; and more specifically, to a high lift feeder protector.

### BACKGROUND

There are a vast array of feeders available for the residential and back yard birding enthusiast to feed birds and/or other animals. Some are designed to sit on a deck railing or the top of a post, but many are designed to be hung up so that birds may reach them and feed without being threatened from terrestrial predators (such as house cats, weasels, foxes, etc.). Additionally, by raising the bird feeder far from the ground, the attempt can be made to reduce access to the feeder by unwanted animals. Whether or not an animal is unwanted at a particular feeder varies widely between persons; regardless, it may be difficult to keep certain types of non-bird species away from feeders. For example, many people do not want to feed pests and are constantly waging a battle to keep them from feeding at what is supposed to be a bird feeder.

There are many unique and novel devices that have been developed in attempts to keep pests from accessing bird feeders. Some are more successful than others. Regardless of their efficacy, many such devices are complex, ugly, expensive and difficult to use. Instead, what some try is to hang their feeders sufficiently far off the ground to keep pests from reaching them. However, such tactics can make accessing such bird feeders to refill them a very difficult and even dangerous job, especially when ladders are involved. Although placing bird feeders far off the ground minimizes access to said feeders from pests jumping upwards from the ground, it still leaves pests the option of climbing whatever tree, pole, or other object the bird feeder is suspended from and then climbing down the rope to reach the bird feeder from above.

What is needed is a device which can suspend bird feeders significant vertical distances from the ground, can protect the suspension rope so that pests can't climb down to the feeder via the rope, and provides the user a simple means of accessing the feeder for refilling, cleaning, etc.

### BRIEF SUMMARY OF THE INVENTION

A high lift feeder protector utilizes a mounting member and a relatively long vertical extension member that extends longitudinally upwards from a mounting member a significant distance above a mounting location. Near an upper distal end, the vertical extension member is attached to, or otherwise becomes, a horizontal extension member. In one embodiment, the horizontal extension member is an inverted “U” shaped member which first extends upwards then gradually bends over before extending downwards, thereby forming an inverted “U” shape. All of the mounting member, the vertical extension member and the horizontal extension member can comprise hollow tubing, cylinders, etc., which allow a suspension rope to run therethrough. The members thereby protect the suspension rope and keep pests and other animals from grasping the rope and using it as a highway to reach the feeder suspended at the end thereof. The suspension rope can be any rope, chain, wire, or other similar material which is relatively strong and yet flexible so that it can easily extend through the members and not get caught up inside them.

The distal end of the suspension rope can be affixed (permanently, removably, quick-detachably, etc.) to the hanging tie off on a bird feeder. If a particular feeder does not have a hanging tie off, one can usually be added quite simply by attachment to an upper surface that is somewhat near the center of gravity of the feeder (to ensure the feeder hangs approximately level). The suspension rope runs upwards from the hanging tie off, into the output port on the underside of the horizontal extension member, through the horizontal extension member, into and through the vertical extension member, into and through the mounting member, and then extends out the input port at the proximal end of the mounting member.

The tag end (or proximal end) of the suspension rope can then be removably affixed to a cleat, tie-off, spool, winch, windlass, hoist, or other securing device for securing the tag end of the suspension rope. If a cleat or other type of tie-off is used, a rope stop should be affixed near the tag end of the suspension rope. The rope stop should be large enough that it can not fit within the input port on the vertical extension member. Thus, even if the user accidentally releases the tag end of the suspension rope, the rope stop will function to stop the rope from feeding completely in and through the vertical and horizontal extension members.

If a winch, hoist, windlass, or other type of rope take-up/play-out device is employed instead as the securing device, the tag end of the rope should be secured within the rope take-up/play-out device; thus, an additional rope stop may not be needed. In another embodiment, a rope stop continues to be employed even in such instances.

By feeding the suspension rope through the inside of the mounting, vertical, and horizontal extension members, the rope is protected from the elements, is effectively out of reach of pests and other climbing animals, and is not exposed to be slapped about in the wind making unwanted noise or looking unsightly. Once the distal end of the suspension rope has been affixed to the feeder tie-off, the proximal end (or tag end) of the suspension rope can be pulled away from the input port of the vertical extension member, thereby drawing the bird feeder upwards towards the output port at the bottom of the horizontal extension member.

When the feeder is at the user-desired height, the tag end of the suspension rope can be affixed to a securing device, thereby keeping the bird feeder at that height. In other embodiments, when a rope take-up/play-out device is used, the device can be stopped and locked when the bird feeder reaches the desired height.

### BRIEF DESCRIPTION OF THE DRAWINGS

FIG. 1 illustrates a front perspective view of an exemplary embodiment of a high lift feeder protector with a bird feeder in a raised position ready for feeding;

FIG. 2 illustrates a front perspective view of an exemplary embodiment of a high lift feeder protector with a bird feeder in a lowered position ready for cleaning and/or filling;

FIGS. 3A, 3B, and 3C illustrate cross-sectional views of exemplary embodiments of the horizontal extension, and/or vertical extension, and/or mounting members of a high lift feeder protector; and

FIG. 4 illustrates a side elevation view of an exemplary embodiment of a high lift feeder protector.

### DETAILED DESCRIPTION

In the following discussion, numerous specific details are set forth to provide a thorough understanding of the present disclosure. However, those skilled in the art will appreciate that embodiments may be practiced without such specific details. Furthermore, lists and/or examples are often provided and should be interpreted as exemplary only and in no way limiting embodiments to only those examples. Similarly, in this disclosure, language such as “could, should, may, might, must, have to, can, would, need to, is, is not”, etc. and all such similar language shall be considered interchangeable whenever possible such that the scope of the invention is not unduly limited. For example, a comment such as: “item X is used” can be interpreted to read “item X can be used”.

Exemplary embodiments are described below and in the accompanying Figures. The following detailed description provides a review of the drawing Figures in order to provide a thorough understanding of, and an enabling description for, these embodiments. One having ordinary skill in the art will understand that in some cases well-known structures and functions have not been shown or described in detail to avoid unnecessarily obscuring the description of the embodiments.

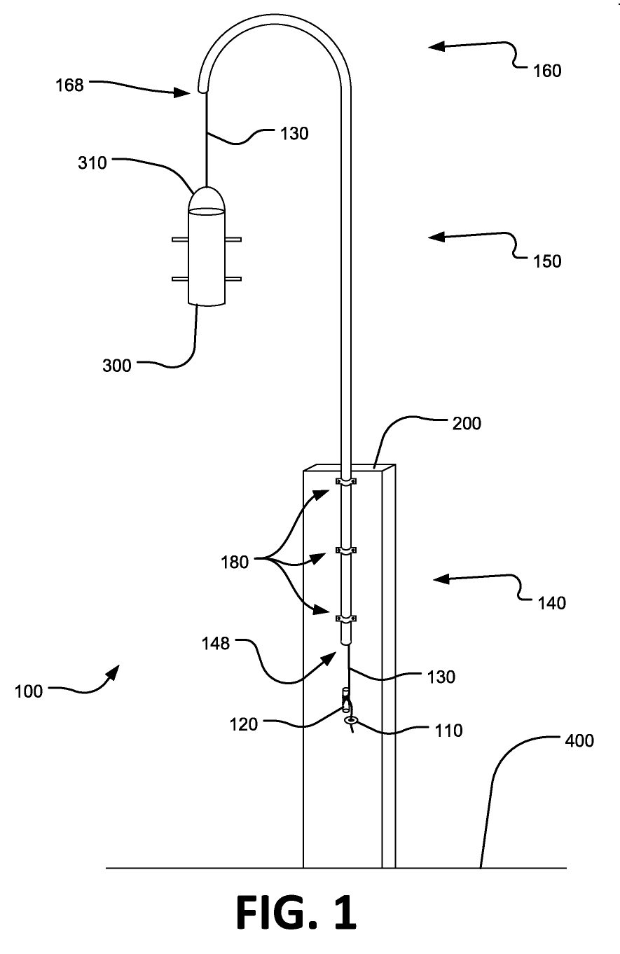

Referring now to the drawings, FIG. 1 illustrates a front perspective view of an exemplary embodiment of a high lift feeder protector 100 with a bird feeder 300 in a raised position ready for feeding. A distal end of a suspension rope 130 can be affixed to the hanging tie off 310 on the bird feeder 300. The connection between the suspension rope 130 and the hanging tie off 310 can be permanent (for instance a crimp, melt, solder, weld, epoxy, hard-knot, glue, bolt, etc.), or it can be removable (such as with a clasp, latch, carabiner, slip knot, hook and loop, etc.) so the bird feeder 300 can be removed and cleaned, filled, replaced, put away for the season, etc.

If a particular feeder 300 does not have a hanging tie off 310, one can usually be added. Attachment of a loop, hook, screw-eye, or similar can be made to an upper surface of the feeder and such can be used as a tie-off.

Once the distal end of the suspension rope 130 has been affixed to the bird feeder 300, the remainder of the rope 130 extends upwards from the feeder 300, into the output port 168 on the underside of the horizontal extension member 160, through the horizontal extension member 160, into and through the vertical extension member 150, then into and through the mounting member 140, and then extends out the input port 148 at the proximal end of the mounting member 140. In another embodiment, the rope need not necessarily run inside/through the mounting member 140 as there is less need to keep this portion of the rope away from pests. However, in yet another embodiment, a protective cover or box can fully enclose the tag end of the rope and securing device 120 as this protects the rope from being chewed on by pests, mice, etc.

The output port 168 can be flared or bell shaped to preclude fraying or otherwise minimize damage or wear to the suspension rope 130, assist the suspension rope 130 in entering the output port 168, and otherwise enhance the smooth operation of the high lift feeder protector 100.

The tag end of the suspension rope 130 can then be removably affixed to a securing device 120 (e.g., a cleat, tie-off, or spool (collectively, cleat), or a winch, windlass, or hoist (collectively, rope take-up/play-out device)) for securing the tag end of the suspension rope 130.

If a fixed securing device 120 such as a cleat or other type of tie-off is used, a rope stop 110 should be affixed near the tag end of the suspension rope 130. The rope stop 110 should be large enough that it can not fit within the input port 148 on the mounting member 140. Thus, even if the user accidentally releases the tag end of the suspension rope 130, the rope stop 110 will function to stop the rope from feeding completely in and through the mounting, vertical and horizontal extension members 140, 150 and 160.

A high lift feeder protector 100 can utilize a relatively long vertical extension member 150 that extends vertically a significant distance above a mounting location (in FIG. 1, the mounting location is a post 200 stuck in the ground 400). The mounting member 140 can attach to the post 200 via a plurality of lock brackets 180. The lock brackets 180 hold the mounting member 140 firmly against the mounting location 200 and help it to provide a solid base for a proximal end of the vertical extension member 150 to be solidly attached thereto. Although the depiction of the mounting brackets 180 in FIG. 1 appears to display only basic brackets, more elaborate and/or ornate mounting devices can be employed. In one embodiment, the mounting devices allow the members to swivel therein so that the bird feeder can be rotated in an arc or otherwise moved horizontally as well as raised or lowered vertically via manipulation of the suspension rope 130.

The vertical extension member 150 extends generally vertically upwards from the mounting member 140. The length of the vertical mounting member 150 can vary, but should be at least long enough to ensure that a pest or other animal can not leap from the mounting member, mounting location, post, nearby fence, the ground, etc. and reach the suspended bird feeder 300 or the horizontal extension member 160.

An upper distal end of the vertical extension member 150 is attached to, or otherwise becomes, a horizontal extension member 160. In one embodiment, the horizontal extension member 160 is an inverted “U” shaped member which first extends upwards then gradually bends over before extending downwards, thereby forming an inverted “U” shape. All of the mounting member 140, the vertical extension member 150 and the horizontal extension member 160 can comprise hollow tubing, cylinders, etc., which allow the suspension rope 130 to run therethrough. The members 140, 150 and 160 thereby protect the suspension rope 130 and keep pests and other animals from reaching the rope and using it as a highway to reach the feeder 300 suspended at the end thereof. The suspension rope 130 can be any rope, chain, wire, or other similar material which is relatively strong and yet flexible so that it can easily extend through the members and not get caught up inside them.

In the embodiment in FIG. 1, the mounting member 140, vertical extension member 150, and horizontal extension member 160 together form a hollow cane through which the suspension rope runs in order to protect the suspension rope from weathering, pests, wear, etc.

If a winch, hoist, windlass, or other type of rope take-up/play-out device is employed as a securing device 120, the tag end of the rope should be secured within the rope take-up/play-out device and so a rope stop 110 may not be needed. A winch, hoist, etc. can be powered so that the user need only push a button or flip a switch to raise or lower the feeder 300. A remote control can be utilized, if desired, so that the height of the feeder can be adjusted from a distance.

Once the distal end of the suspension rope 130 has been affixed to the feeder securing device 120, the proximal end (or tag end) of the suspension rope 130 can be pulled from the input port 148 of the mounting member 140, thereby drawing the bird feeder 300 upwards towards the output port 168 at the bottom of the horizontal extension member 160. When the feeder is at the user-desired height, the tag end of the suspension rope 130 can be affixed to a securing device 120 or other cleat tie-off, thereby keeping the bird feeder at that height. In other embodiments, when a rope take-up/play-out device is used, the device can be stopped and locked when the bird feeder reaches the desired height.

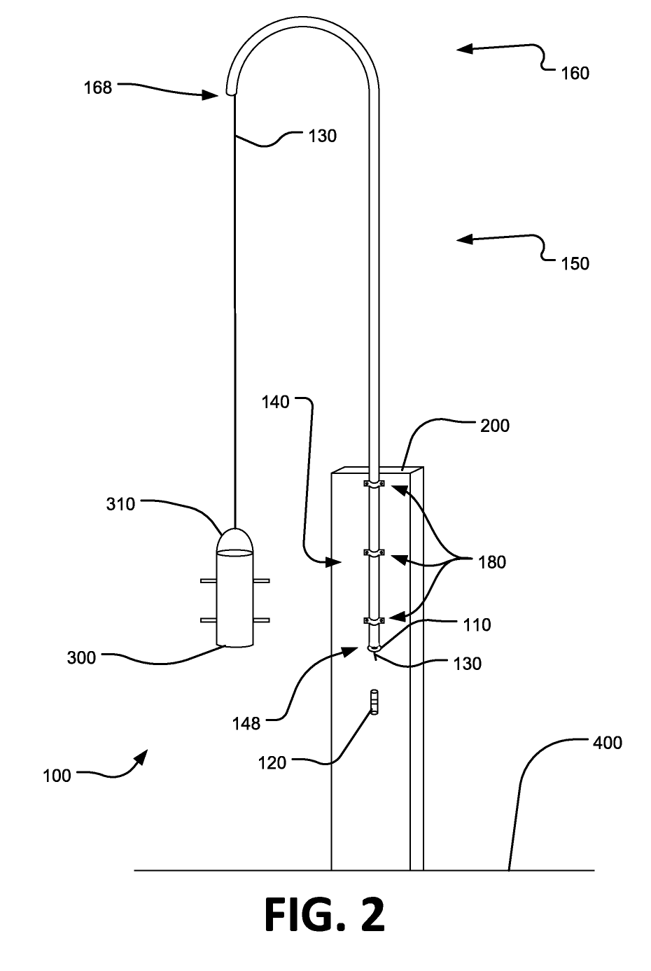

FIG. 2 illustrates a front perspective view of an exemplary embodiment of a high lift feeder protector 100 with a bird feeder 300 in a lowered position ready for cleaning and/or filling. Note that in this view, the suspension rope 130 is unwound from the securing device 120 and the rope stop 110 is in contact with the input port 148, thereby stopping the tag end of the rope from passing completely through the members. The feeder 300 is thus suspended in a lowered position so that it can be easily cleaned, filled, removed, etc. as needed. In the embodiment illustrated in FIG. 2, the suspension rope 130 is not long enough to allow the feeder 300 to be lowered completely to the ground; in other embodiments, the suspension rope 130 is that long or longer such that the feeder can be lowered completely to rest on the ground.

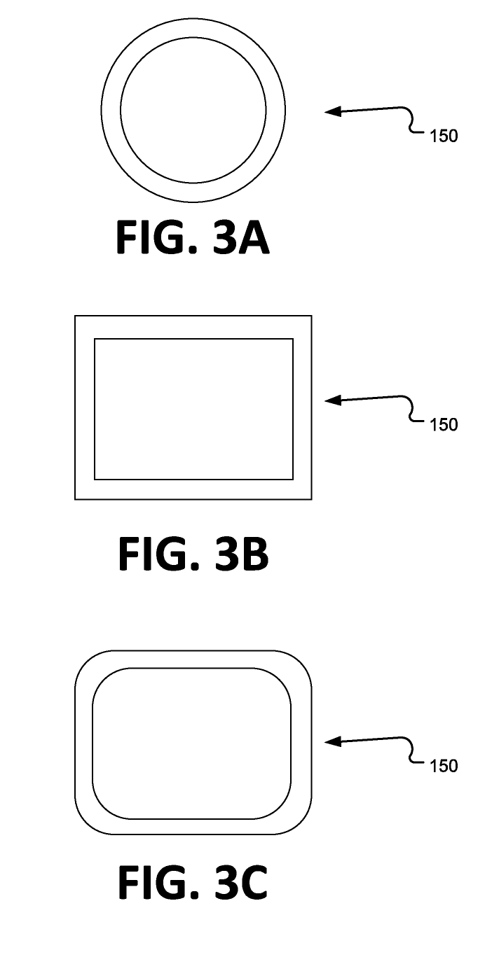

FIGS. 3A, 3B, and 3C illustrate cross-sectional views of exemplary embodiments of the horizontal extension, and/or vertical extension, and/or mounting members 140, 150 and 160 of a high lift feeder protector. FIG. 3A illustrates a type of oval ring (which can be an ellipse, circle, or other similar constructs). FIG. 3B illustrates a type of polygonal ring (for example, a triangle, rectangle, square, etc. construct). FIG. 3C illustrates a rounded polygonal ring. In other embodiments, the members 140, 150 and 160 can have cross sections that resemble other types of hollow-ringed constructs. In yet other embodiments, c-channel, irregular polygonal, or curved shapes can be used.

Although FIGS. 3A, B and C illustrate cross-sections labeled 150 for vertical extension members, they can also represent the cross-sections of mounting members 140 and/or horizontal extension members 160.

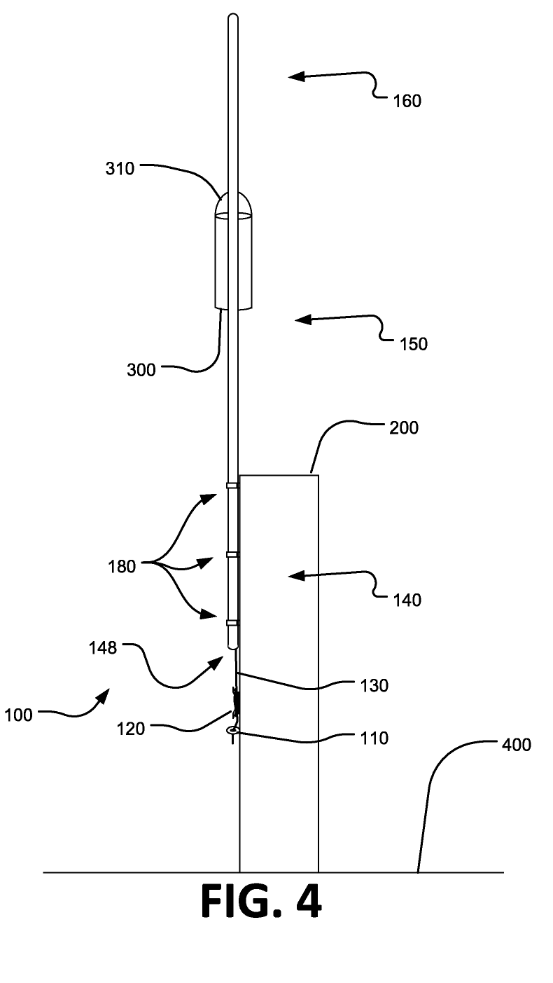

FIG. 4 illustrates a side elevation view of an exemplary embodiment of a high lift feeder protector 100. In this view, the plurality of exemplary lock brackets 180 can be seen attaching the mounting member 140 to the mounting location 200. Although the mounting location 200 shown in FIG. 4 is a post, other mounting locations are contemplated, such as building eaves, roofs, and walls; fences; concrete pads or footers; the ground 400; barriers and other upright wall structures; deck railings, structural members, or other deck portions; etc.

The plurality of lock brackets 180 hold the mounting member 140 firmly against the mounting location 200 and help it to provide a solid base for the vertical extension. Although the mounting brackets 180 illustrated in FIG. 4 are just basic brackets, more elaborate and/or ornate mounting devices can be employed. In one embodiment, the mounting devices 180 allow the members to swivel therein so that the bird feeder can be rotated in an arc or otherwise moved horizontally as well as raised or lowered vertically (via manipulation of the suspension rope 130).

While particular embodiments have been described and disclosed in the present application, it is clear that any number of permutations, modifications, or embodiments may be made without departing from the spirit and the scope of this disclosure.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, as well as those listed above, are incorporated herein by reference in their entirety. Aspects of embodiments can be modified, if necessary, to employ the systems, functions, and concepts of the various references to provide yet further embodiments.

In light of the above “Detailed Description,” the inventor may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventor. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventor contemplates the various aspects in any number of claim forms. Accordingly, the inventor reserves the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the invention.

What is claimed is:

1. A high lift feeder protector for raising a feeder above a ground surface, comprising:
a vertical extension member extending longitudinally along a generally vertical axis from a vertical extension member proximal end attaching to a mounting member, to a vertical extension member distal end attaching to a horizontal extension member;
the vertical extension member positioned generally above the mounting member;
the mounting member attaching to a mounting location via a plurality of lock brackets;
the horizontal extension member extending generally horizontally away from the vertical axis, spacing the feeder therefrom;
the horizontal extension member is arched to reduce friction on a suspension rope running therethrough for protection of the suspension rope;
a horizontal extension member distal end having an output port out of which a distal end of the suspension rope extends;
the distal end of the suspension rope removably attaching to the feeder;
the suspension rope extending through the horizontal extension member and into the vertical extension member;
the suspension rope extending through the vertical extension member and into the mounting member;
a proximal end of the suspension rope extending through the mounting member and out an input port on a proximal end of the mounting member;
the proximal end of the suspension rope attached to a rope stop, the rope stop being larger than an inside opening of the input port so that the rope stop can not fit through the input port, thus preventing the rope stop and the attached proximal end of the suspension rope from passing into and through the input port and stopping the feeder from falling free;
the suspension rope removably affixing to a securing device; and
affixing the suspension rope to the securing device at a point on the suspension rope further away from the proximal end of the suspension rope raises the feeder higher above the ground surface while affixing the suspension rope to the securing device at a point on the suspension rope closer to the proximal end of the suspension rope lowers the feeder closer to the ground surface.

2. The high lift feeder protector of claim 1 wherein each of the plurality of lock brackets hold the mounting member firmly to the mounting location while simultaneously enabling the high lift feeder protector to rotate about the vertical axis.

3. The high lift feeder protect of claim 1 wherein a cross-section of at least one of the horizontal extension member, the vertical extension member, and the mounting member is an oval ring.

4. The high lift feeder protect of claim 2 wherein a cross-section of at least one of the horizontal extension member, the vertical extension member, and the mounting member is an oval ring.

5. The high lift feeder protect of claim 1 wherein a cross-section of at least one of the horizontal extension member, the vertical extension member, and the mounting member is a polygonal ring.

6. The high lift feeder protect of claim 2 wherein a cross-section of at least one of the horizontal extension member, the vertical extension member, and the mounting member is a polygonal ring.

7. The high lift feeder protect of claim 1 wherein a cross-section of at least one of the horizontal extension member, the vertical extension member, and the mounting member is a rounded polygonal ring.

8. The high lift feeder protect of claim 2 wherein a cross-section of at least one of the horizontal extension member, the vertical extension member, and the mounting member is a rounded polygonal ring.

9. A high lift feeder protector for raising a feeder above a ground surface, comprising:
a vertical extension member extending longitudinally along a generally vertical axis from a vertical extension member proximal end attaching to a mounting member, to a vertical extension member distal end attaching to a horizontal extension member;
the vertical extension member positioned generally above the mounting member;
the horizontal extension member extending generally horizontally away from the vertical axis, spacing the feeder therefrom;
together, the mounting member, vertical extension member, and the horizontal extension member forming a hollow cane;
a suspension rope running through the hollow cane for protection of the suspension rope;
a horizontal extension member distal end having an output port out of which a distal end of the suspension rope extends;
the distal end of the suspension rope removably attaching to the feeder;
a proximal end of the suspension rope extending out an input port on a proximal end of the mounting member;
the proximal end of the suspension rope attached to a rope stop, the rope stop being larger than an inside opening of the input port so that the rope stop can not fit through the input port, thus preventing the rope stop and the attached proximal end of the suspension rope from passing into and through the input port and stopping the feeder from falling free;
the suspension rope removably affixing to a securing device; and
affixing the suspension rope to the securing device at a point on the suspension rope further away from the proximal end of the suspension rope raises the feeder higher above the ground surface while affixing the suspension rope to the securing device at a point on the suspension rope closer to the proximal end of the suspension rope lowers the feeder closer to the ground surface.

10. The high lift feeder protector of claim 9 further comprising:
the mounting member attaching to a mounting location via a plurality of lock brackets; and
each of the plurality of lock brackets holding the mounting member firmly to the mounting location while simultaneously enabling the high lift feeder protector to rotate about the vertical axis.

11. The high lift feeder protect of claim 9 wherein a cross-section of at least one of the horizontal extension member, the vertical extension member, and the mounting member is an oval ring.

12. The high lift feeder protect of claim 10 wherein a cross-section of at least one of the horizontal extension member, the vertical extension member, and the mounting member is an oval ring.

13. The high lift feeder protect of claim 9 wherein a cross-section of at least one of the horizontal extension member, the vertical extension member, and the mounting member is a polygonal ring.

14. The high lift feeder protect of claim 10 wherein a cross-section of at least one of the horizontal extension member, the vertical extension member, and the mounting member is a polygonal ring.

15. The high lift feeder protect of claim 9 wherein a cross-section of at least one of the horizontal extension member, the vertical extension member, and the mounting member is a rounded polygonal ring.

16. The high lift feeder protect of claim 10 wherein a cross-section of at least one of the horizontal extension member, the vertical extension member, and the mounting member is a rounded polygonal ring.
